(19) United States
(12) Patent Application Publication
(10) Pub. No.: US 2005/0054438 A1
(43) Pub. Date: Mar. 10, 2005

(54) Universal personal identifier for accessing patron information at a gaming venue

(76) Inventors: Wayne H. Rothschild, Northbrook, IL (US); Richard T. Schwartz, Chicago, IL (US); Jared A. Torres, Chicago, IL (US)

Correspondence Address: JENKENS & GILCHRIST, P.C., 225 WEST WASHINGTON, SUITE 2600, CHICAGO, IL, 60606, US

(21) Appl. No.: 10/655,488

(22) Filed: Sep. 4, 2003

(51) Int. Cl. A63F 13/00

(52) U.S. Cl. 463/29

(57) ABSTRACT

A method and apparatus for associating a patron with wagering game play at a gaming machine in a server-based gaming network is disclosed. The method includes associating a unique patron identification with the patron, establishing a patron account for the patron where the patron account is identified by the unique patron identification, associating the gaming machine with a universal personal identifier device for receiving a universal personal identifier having a patron identification where the universal personal identifier device is capable of detecting and transmitting the patron identification, receiving the patron identification, comparing the patron identification to the unique patron identification, and enabling collection of patron accounting data resulting from wagering game play if the patron identification matches the unique patron identification. The universal personal identifier device may be a card reader, a touch screen, a biometric device, a Bluetooth™ module device, a microchip scanner, or a combination thereof.

### FIELD OF THE DISCLOSURE

The present invention relates generally to gaming machines, and, more particularly, to the use of a universal personal identifier for accessing patron information at a gaming venue.

### BACKGROUND

Gaming machines providing games such as electronically driven video slots, video poker, video blackjack, video keno, video bingo, video pachinko, video lottery, and mechanically driven reel slots, etc., are well known in the gaming industry. Generally gaming machines are configured to operate as “stand-alone” units (that may or may not be coupled to a backroom computer) where the outcome of game play is locally determined, or as part of a server-based gaming network where the outcome of game play may be either locally determined or “centrally determined”.

Server-based gaming networks typically include a number of gaming machines, communicatively coupled via a dedicated (i.e., non-public or intranet) communication network to one or more server(s). Future server-based gaming networks may include gaming machines and servers communicatively coupled via a public communication network (i.e., internet). Because of their versatility, server-based gaming networks enable a gaming venue operator (e.g., Harrah's) to access to many types of gaming machine data including, player tracking data, gaming machine performance data, accounting data (e.g., coin-in received by each gaming machine), security data, and maintenance data, to name a few.

A gaming machine, whether configured as a stand-alone unit or as part of a server-based gaming network, may be included as part of a player tracking system which tracks individual player usage of the gaming machines. In prior art player tracking systems, a gaming venue operator issues a gaming-operator-specific player tracking card (“player tracking card”) to the player that has encoded thereon player/patron identification information (e.g., player tracking number, player name, address, etc.). When the player inserts his/her player tracking card into a card reader of a gaming machine prior to beginning game play, the card reader reads the player/patron identification information and informs a player tracking server or any other computer coupled to the gaming machine, of the player's subsequent gaming activity.

Because of the ease with which they can monitor individual player usage, player tracking systems utilizing player tracking cards have become integral to gaming venue success. Use of the player tracking card allows the operator to understand and analyze the player's gaming habits with precision, thus enabling the operator to provide a gaming venue with improved operating efficiencies. In addition, data gathered using prior art player tracking systems enable operators to target individual players with direct marketing techniques and rewards commensurate with game play frequency and intensity. For example, an operator or a manufacturer noting a player's identity via the player tracking card may use wagering data associated with game play by the player to reward the player with promotional incentives or enhanced game incentives. The promotion incentives can vary and may include rewards such as double credits for wagering game play or a VIP Club card that enables the player to accumulate points redeemable for free meals, show tickets, overnight accommodations, trips and other gifts, including cash-back options and even free air travel, to name a few. As a result of receiving incentives and rewards based on tracked game play, player loyalty typically increases as the player is encouraged to frequent that particular operator's gaming venue despite the possible intrusiveness into the player's private gaming and spending habits.

Unfortunately, receiving rewards is often predicated on the player physically possessing the correct player tracking card for the selected gaming venue at the time of game play. If the player forgot to bring the correct player tracking card, he/she may choose to abstain from gaming machine play at that operator's gaming venue because his/her patronage can not be tracked during that particular visit and subsequently regarded. Further, the time consuming process of signing up for another account or having a duplicate player tracking card issued is often a deterrent to gaming machine play. As a result of not having the correct player tracking card for that particular operator's gaming venue, the player may choose to limit his/her play at that venue on that occasion or even take his/her business to another operator's gaming venue.

Numerous prior art solutions have been proposed to address this problem of not having the “correct” player tracking card for that particular operator's gaming venue. One prior art solution suggests implementing a card-less player tracking system where a player can participate in the player tracking system by simply entering identity information such as their player tracking number or other identifying information. Unfortunately, these card-less player tracking systems have not been embraced by the gaming operators. Security issues such as authentication and player reluctance to memorize complicated player tracking numbers or other cumbersome identifying information are a limitation to implementing prior art card-less player tracking systems. Further, traditional player tracking card systems have been designed and implemented for independent stand alone use by operators at their venues only. They are not designed or implemented for multi-operator systems that include different venues owned by different operators.

### SUMMARY OF THE INVENTION

The present invention provides a method and server-based gaming system configured to associate a patron with wagering game play at a gaming machine and to associate a patron with patron spending activity at a point of sale (POS) terminal. The method and server-based gaming system configured to associate a patron with wagering game play and spending activity may be implemented alone or in conjunction with existing player tracking systems. The method includes associating a unique patron identification with the patron, establishing a patron account for the patron where the patron account is identified by the unique patron identification, associating the gaming machine with a universal personal identifier device for receiving a universal personal identifier having a patron identification where the universal personal identifier device is capable of detecting and transmitting the patron identification, receiving the patron identification, comparing the patron identification to the unique patron identification, and enabling collection of patron accounting data resulting from wagering game play if the patron identification matches the unique patron identification. The patron accounting data includes accounting data and game play data (e.g., the types of game play choices that the patron makes during primary and secondary game play, the time the patron leaves the gaming machine, the patron's wagering patterns, the types of games played, the speed of wagering game play, etc). The universal personal identifier device may be a card reader, a touch screen, a biometric device, a Bluetooth™ module device, a microchip scanner, or a combination thereof associated with the gaming machine. The universal personal identifiers may therefore include magnetic cards such as credit cards, optical cards, bar coded cards, memory cards, etc., patron entry of identifying information unique to the patron that is easily remembered and does not require the patron to carry an item having the identifying information, biometrics inputs, Bluetooth™ portable devices, embedded microchips, or combinations thereof presented by a patron at a gaming venue.

The server-based gaming system, allowing a patron with a universal personal identifier to be associated with wagering game play at a gaming machine, includes a plurality of gaming machines and a server operatively coupled to the gaming machines. At least one of the gaming machines includes a value input device, a video display capable of displaying video images, a universal personal identifier device configured to receive a universal personal identifier having a patron identification and configured to detect the patron identification from the universal personal identifier, and a gaming machine controller operatively coupled to the value input device, the video display and the universal personal identifier device, the gaming machine controller having a processor and a memory coupled to the processor of the gaming machine controller. The gaming machine controller is programmed to receive the patron identification from the universal personal identifier device, to allow the patron to make a wager for the wagering game play, to cause a video image representing an outcome of the wagering game play to be displayed on the video display, and to determine a value payout associated with the outcome. The server includes a server controller having a processor and a memory coupled to the processor of the server controller. The server controller is programmed to associate a unique patron identification with the patron, to establish a patron account for the patron, the patron account being identified by the unique patron identification, to receive the patron identification from the gaming machine controller, to compare the patron identification to the unique patron identification, and to enable collection of patron accounting data resulting from the wagering game play if the patron identification matches the unique patron identification.

Similarly, the present invention provides a method and apparatus for associating a patron with spending activity at a point of sale terminal in the server-based gaming network. Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a block diagram of an embodiment of a server-based gaming system utilizing universal personal identifiers in accordance with the invention.

FIG. 2 is a perspective view of an embodiment of a gaming machine of FIG. 1 configured to receive universal personal identifiers.

FIG. 3 is a block diagram of the electronic components of the gaming machine of FIG. 1.

FIG. 4 is an exemplary high level ladder diagram illustrating the use of a Bluetooth™ technology based personal identifier for accessing a patron account at the server-based gaming system of FIG. 1.

### DESCRIPTION OF THE PREFERRED EXAMPLES

The description of the preferred examples is to be construed as exemplary only and does not describe every possible embodiment of the invention. Numerous alternative embodiments could be implemented, using either current technology or technology developed after the filing date of this patent, which would still fall within the scope of the claims defining the invention.

In general, the present invention provides a method and server-based gaming system configured to associate a patron with wagering game play at a gaming machine and to associate a patron with patron spending activity at a point of sale terminal. The method and server-based gaming system configured to associate a patron with wagering game play and spending activity may be implemented alone or in conjunction with existing player tracking systems. The method includes associating a unique patron identification with the patron, establishing a patron account for the patron where the patron account is identified by the unique patron identification, associating the gaming machine with a universal personal identifier device for receiving a universal personal identifier having a patron identification where the universal personal identifier device is capable of detecting and transmitting the patron identification, receiving the patron identification, comparing the patron identification to the unique patron identification, and enabling collection of patron accounting data resulting from wagering game play if the patron identification matches the unique patron identification. The patron accounting data includes accounting data and game play data such as the types of game play choices that the patron makes during primary and secondary game play, the time the patron leaves the gaming machine, the patron's wagering patterns, the types of games played, the speed of wagering game play, etc. The universal personal identifier device may be a card reader, a touch screen, a biometric reader, a Bluetooth™ module device, a microchip scanner, or a combination thereof associated with the gaming machine. The universal personal identifiers may include magnetic cards, optical cards, bar coded cards, memory cards, etc., patron entry of identifying information unique to the patron that is easily remembered and does not require the patron to carry an item having the identifying information, biometrics inputs, Bluetooth™ portable devices, embedded microchips, or combinations thereof presented by a patron at a gaming venue.

In one embodiment, associating the unique patron identification with the patron and establishing the patron account may be accomplished quickly at the gaming machine. For example, associating the unique patron identification and establishing the patron account may be initiated by the patron inserting a universal personal identifier card such as a credit card in a suitable card reader of the gaming machine. A server coupled to the gaming machine may then associate the unique patron identification with the patron and establish the patron account. Subsequent game play by the patron can be rewarded by the gaming venue operator in the form of free promotional credits, double credit awards for game play, etc., dispensed to the patron from the patron's account while at the gaming machine. If additional information is provided by the patron at the gaming machine (e.g., email address, home address, etc. entered via a touch screen) the gaming venue operator may also reward the patron via mail promotions that may include reduced hotel room rates, free dining, free entertainment shows, etc.

In another embodiment, associating the unique patron identification with the patron and establishing the patron account may be accomplished through a more formal registration procedure. For example, if a biometric input is used as a universal personal identifier, associating the unique patron identification with the patron and establishing the patron account may be accomplished by (1) the patron submitting to the gaming operator his/her biometric profile (e.g., a fingerprint, a retinal scan, etc.,) as well as various other types of information such as name, address, social security number, credit card number(s), (2) the patron's biometric profile being used as the patron's unique patron identification or being converted to the patron's unique patron identification, and (3) a patron account being established and associated with the unique patron identification. Subsequent to the more formal registration procedure, the patron can utilize his/her biometric profile at the gaming machine to access his/her patron account or, in conjunction with another universal personal identifier (e.g., a credit card), to independently authenticate his/her identity. Wagering game play by the patron can then be rewarded by the gaming venue operator.

Similarly, the present invention provides a method and apparatus for associating a patron with spending activity at a point of sale terminal in the server-based gaming network.

Thus, universal personal identifiers such as a credit card with a magnetic stripe having the holder's unique patron identification thereon, readable by a suitable card reader at a gaming machine, a point of sale terminal, a cash machine, etc., may be thought of as true “universal identifiers”. That is, the patron can be readily identified without having previously registered using the more formal registration procedure. On the other hand, use of universal personal identifiers associated with biometric profiles, patron entry of identifying information unique to the patron, Bluetooth™ portable devices, and embedded microchips, while also being universal identifiers, may require that the patron initially register with one or more gaming venue operators to incorporate the patron's unique patron identifier into a reference database. Subsequently, the patron can be readily identified upon presentation of their universal personal identifier (and therefore their unique patron identification) at a gaming terminal or point of sale terminal when the patron's unique patron identification is correlated to the patron's account.

An advantageous feature of the present invention enabling patron identification at a gaming venue using one of any number of the universal personal identifiers described above is that patron accounting data and associated information can be accessed by the gaming operator and/or the identified patron without the restrictions typically associated with traditional operator-specific player tracking cards. Thus, a patron who forgets to bring his/her traditional player tracking cards to the operator's gaming venue will not be penalized in terms of incentive awards, will not have to reapply for another operator-specific player tracking card and will not have to limit game play at that operator's venue on that occasion or go to another operator's gaming venue. Utilization of one of the universal personal identifiers at the gaming machine and/or at the POS terminal therefore frees the patron from the burden of carrying different player tracking cards for different operator's gaming venues and frees the patron from the burden of the having to remember to bring the correct player tracking card to a particular operator's gaming venue.

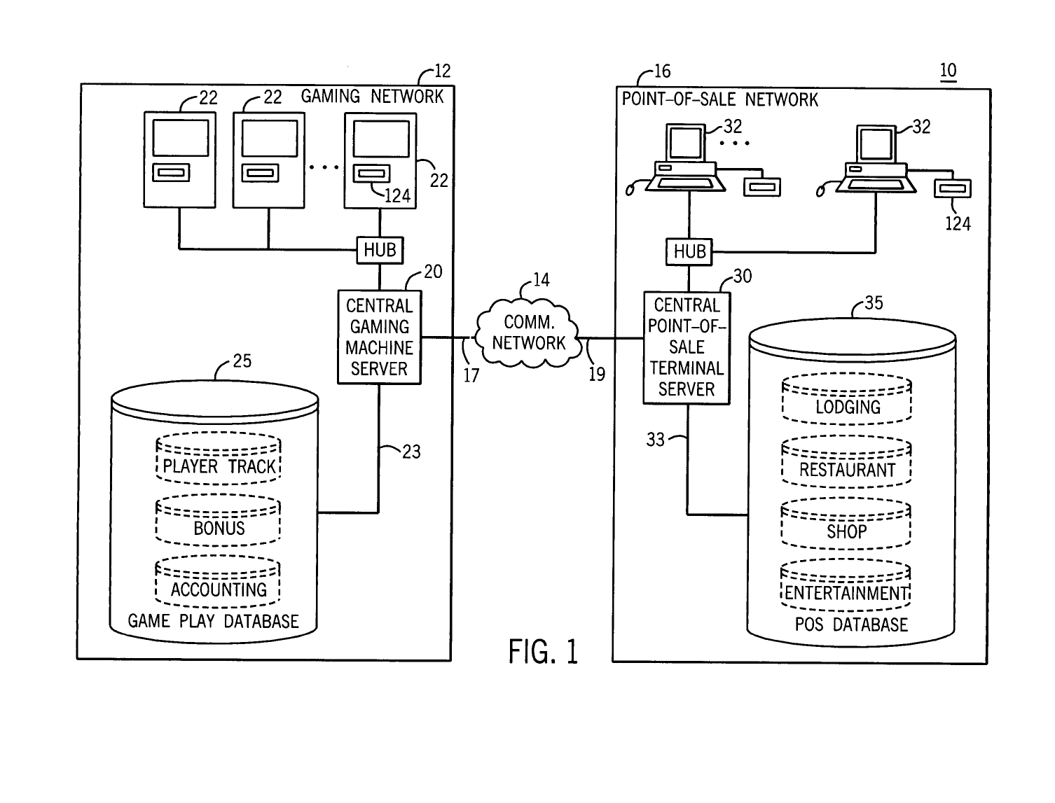

FIG. 1 is a block diagram of an embodiment of a server-based gaming system 10 utilizing one or more universal personal identifier(s) in accordance with the invention. As will be described below in detail, the server-based gaming system 10 provides for integrated patron tracking and patron accounting data correlation utilizing one or more of a number of types of universal personal identifiers including universal patron identification cards, biometric inputs utilizing biometric devices or methods, Bluetooth™ portable devices such as cellular phones or PDAs, embedded human identification microchips or combinations thereof. This allows both players having universal personal identifiers and operators having suitably configured gaming machines to access patron information that, in addition to patron game play habit data and spending habit data, includes bonus credit awards awarded to the patron by the operator, promotional schemes tailored to the patron's habits, tax information, etc. Unlike traditional prior art player tracking systems that require patrons to use operator-specific player tracking cards (“player tracking cards”) to identify themselves, the server-based gaming system 10 allows patrons to conveniently and efficiently identify themselves using one of the number of types of universal personal identifiers. In addition, unlike most prior art player tracking systems where a patron's identity is generally associated only with accounting data resulting from wagering game play (and rewarded accordingly), the server-based gaming system 10 enables a patron's identity to be associated with patron accounting data resulting from any or all spending activity at a gaming operator's venue or across multiple gaming venues. Therefore, in addition to patron accounting data generated from wagering game play, accounting data from dining, shopping, entertainment, lodging, and parking may be collected, tracked, mined and used to reward the patron accordingly. As a result, the spending habits of a patron (i.e., a wagering game “player” and/or a “customer” of the restaurants, stores, lounges, etc. at the gaming venue) can be monitored and rewarded without the need for an operator-specific player tracking card.

Referring to FIG. 1, the server-based gaming system 10 includes a gaming network 12 operatively coupled to a communication network 14 via a first network link 17, and a point-of-sale network 16 operatively coupled to the communication network 14 via a second network link 19. The communication network 14 may be a public communications network, for example, the Internet, or it may be a dedicated private network, for example, an intranet or a private high speed Ethernet network. In either case, the communication network 14 may be reconfigurable and may include multiple location sites. Further, the communication network 14 may be configured in any number of ways including a local area network (LAN) or a wide area network (WAN). If configured as an intranet LAN or WAN, the communication network 14 may be implemented using a dedicated hardwired systems (e.g., private leased phone lines) or a wireless system (e.g., private microwave or satellite links, wireless links) using any number of topologies including a ring topology, a tree topology, a full or partial mesh topology, etc. If configured to include an Internet portion, the communication network 14 may accommodate virtual private network (VPN) tunneling protocols between the gaming networks 12 and the point-of-sale network 16 via the first and second network links 17, 19. The communication network 14, gaming networks 12 and the point-of-sale network 16 may also include additional network elements such as routers, firewalls, servers, controllers, switches, etc. to accommodate variations in network interfaces. Although one gaming network 12 and one point-of-sale network 16 are shown in the illustrated example, it is contemplated that the server-based gaming system 10 may include additional gaming networks 12 and/or point-of-sale networks 16 for single operator or multiple operator systems.

The gaming network 12 and the point-of-sale network 16 may be co-located in a first casino location. Alternatively, multiple gaming networks 12 and associated multiple point-of-sale networks 16, owned or operated by a single operator or by multiple operators, may be located in the multiple casinos that may or may not be in the same geographic region. For example, a first gaming network 12 may be provided in a casino located in Missouri while a second gaming network 12 and the point-of-sale network 16 may be provided in a casino located in Illinois.

In the illustrated example, the gaming network 12 includes three gaming machines 22 interconnected to a central gaming machine server 20 via a bus or data link 23. Similarly, the point-of-sale (POS) network 16 includes two POS terminals 32 interconnected to a central POS terminal server 30 via a bus or data link 33. The data links 23, 33 may be configured using copper wire cable, fiber optic cable, an optical wireless link or any other suitable link capable of transmitting and receiving gaming data. In addition, the connection enabled via the data links 23, 33 may be continuous or intermittent (e.g., event driven), depending on the desired configuration.

Although only three gaming machines 22 and two POS terminals 32 are shown, it is contemplated that more or less gaming machines 22, POS terminals 32 and/or servers may be included depending on the desired configuration and functionality of the server-based gaming system 10. For example, the gaming network 12 may include thousands of gaming machines (providing hundreds of different games) interconnected to many servers (providing a variety of functions) via the data link 23. In addition, although not shown, the gaming network 12 and the POS network 16 may also include additional devices such as firewalls for perimeter defense, security servers to administer access control, etc. For example, the gaming network 12 may include a security server configured to perform data integrity assurance functions, intrusion detection functions, antivirus functions, security report generation, etc.

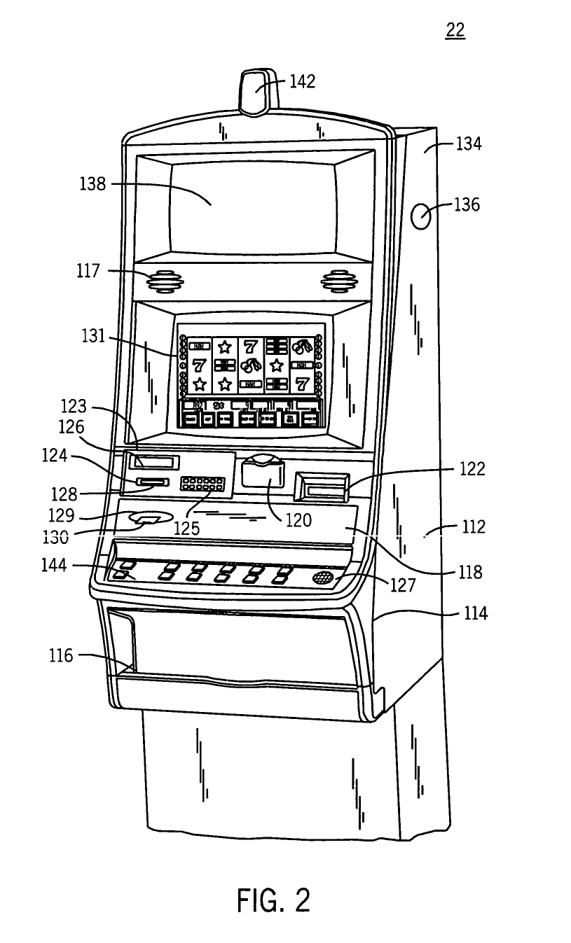

Each of the gaming machines 22 and the POS terminals 32 include a card reader 124 (described in detail in connection with FIG. 2) capable of reading one or more types of suitable universal personal identifier cards (e.g., magnetic cards, optical cards, bar coded cards, and memory cards including compact flash cards, memory sticks, smart cards, radio frequency (RF) cards, combination smart cards, hybrid cards, etc.).

In addition, each of the gaming machines 22 and the POS terminals 32 may include a biometric reader(s) 127 and/or touch screens (described in detail in connection with FIG. 2) configured to allow a patron to identify themselves using biometric means (e.g., finger print, retinal scan, facial scan, etc.) or other identifying means. The other identifying means may include a PIN number, a drivers license number, a credit card number, the patron's height, shoe size, or hat size, the last 4 digits of the patrons home phone number, the last 4 digits of the patron's social security number, a numeric address, the patron's first name, last name, middle name or a combination thereof, the name of a pet owned by the patron, the patron's mother's maiden name, city of birth, favorite color, lucky number, wedding date, etc. Similarly, a combination of the card reader 124, the biometric reader 127, and/or the touch screen, etc., may be included in the gaming machines 22 and the POS terminals 32 to first, enable patron identification via inserting or swiping the universal personal identifier card in the card reader 124 and to second, enable authentication of the patron identification using a biometric input (via the biometric reader 127) or using patron entry of identifying information unique to the patron (via the touch screen).

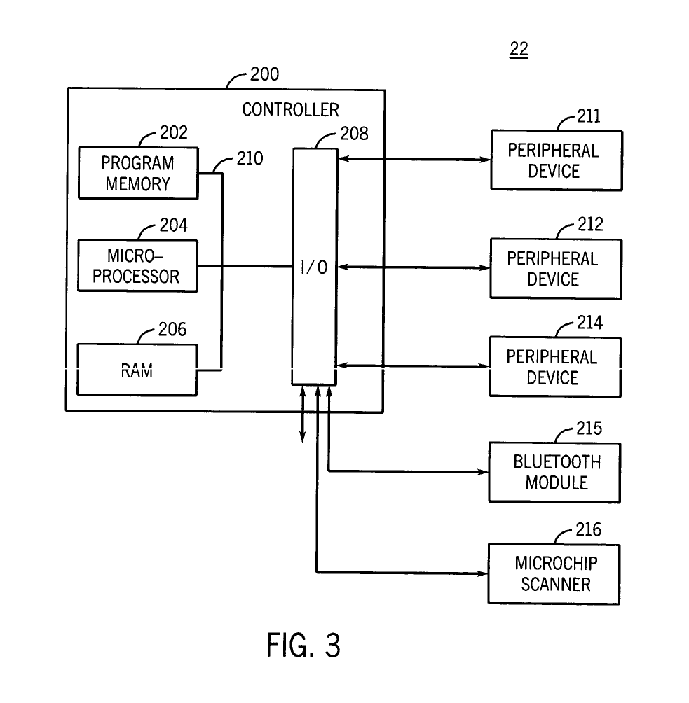

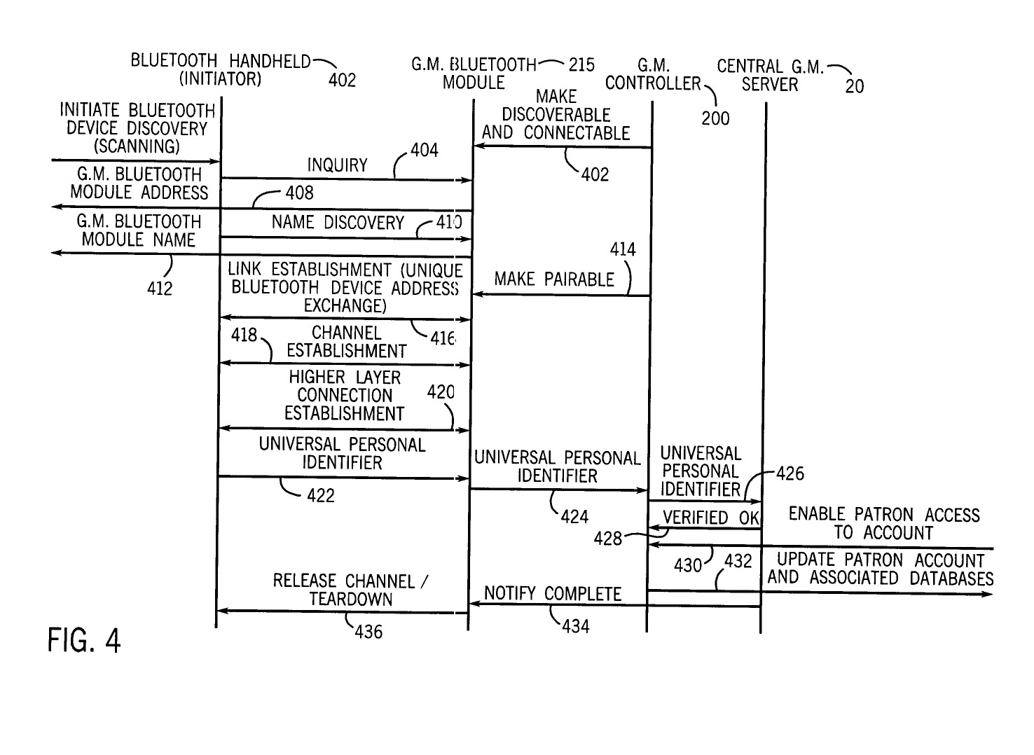

Further, each of the gaming machines 22 and the POS terminals 32 may be configured with a Bluetooth™ module 215 (see, FIGS. 3 and 4) to enable personal identification of a patron via short range wireless communication. For example, using a Bluetooth™ mobile telephone at the gaming machine 22 or POS terminal 32, the patron can identify himself/herself to the server-based gaming system 10 via a unique 48-bit number associated with the unique patron identification transmitted from the Bluetooth™ mobile telephone. Subsequent patron accounting data generated via game play or spending activity can then be collected and used to reward the patron accordingly.

Additionally, the gaming machines 22 and the POS terminals 32 may be configured with a microchip scanner 216 (see, FIG. 3) capable of reading a patron's serial number from an implanted microchip (e.g., a VeriChip™). The patron's serial number is linked to the unique patron identification. Thus, once implanted in patron's arm for example, the microchip linked to the unique patron identification can be used by suitably equipped gaming machines 22 and the POS terminals 32 to enable patron identification for purposes of game play and spending activity tracking.

Gaming Network

Referring to the gaming network 12, each of the gaming machines 22 may be configured in one of any number of configurations to provide wagering games (e.g., mechanically driven spinning reel slots, video slots, video poker, video blackjack, video keno, video bingo, video pachinko, and video lottery) and/or bonus (e.g., Hollywood Squares, Reel 'Em In, Monopoly Money), and/or progressive games, bonus games, etc. The wagering, progressive and bonus games as well as game options such as hold percentages, return-to-patron percentages, game play denominations, minimum wager amounts, lighting configurations, sound configurations, etc., may reside directly on memory devices within the gaming machines 22 or may be downloaded from high capacity storage devices such as CD ROMs, DVDs, hard drives, compact flash memory, etc., or from the central gaming machine server 20 using suitable authentication and/or encryption techniques. Thus, a wagering game conducted at a gaming machine 22 may be enabled at the gaming machine level, at the central gaming machine server level, or at a hybrid gaming machine/server level, depending on the configuration of the server-based gaming system 10.

The central gaming machine server 20, including among other things a microprocessor, a clock, and an operating system, is configured to monitor and issue commands to, and/or download gaming software to the gaming machines 22. In addition, the central gaming machine server 20 is configured to collect and integrate patron identification data and associated patron accounting data resulting from wagering game play, and then analyze the patron accounting data using data mining or other suitable techniques. The patron accounting data may include, among other things, audit data (e.g., the amount of coins or value input received and the value paid out by each gaming machine), gaming machine performance data, gaming manufacturer configuration data, maintenance data, security data, game play data such as the types of game play choices that the patron makes during primary and secondary game play, etc., and game outcome data (for gaming networks having central determination), to name a few. Therefore, when a universal personal identifier such as a credit card, a fingerprint scan, patron entry of place of birth and mother's maiden name, a Bluetooth™ mobile phone, etc., is detected via a suitable device of the gaming machine 22 (e.g., the card reader 124), the central gaming machine server 20 can associate the individual patron's identity with patron accounting data collected during past and subsequent game play and further allow the patron to access their patron account information from one or more venue locations suitably configured.

A game play data storage device or database 25, communicatively coupled to the central gaming machine server 20 via the bus or data link 23, enables data storage and retrieval of the patron identification and patron accounting data resulting from game play. Although one game play database 25 is illustrated, it is contemplated that more or less databases may be included in the gaming network 12. In addition, although not shown, a game play database controller or server may be included in the gaming network 12 for management of the game play database 25.

As mentioned above, the central gaming machine server 20 is configured to collect and integrate patron identification data and associated patron accounting data resulting from game play for identified patrons. First-time identification of a patron, where a unique patron identification is associated with the patron and a patron account associated with the unique patron identification is established, may be accomplished using one of a number of “registration” methods. In one embodiment, a quick patron registration procedure initiated by the patron at the gaming machine 22 or another designated machine of the server-based gaming system 10 may simply require a patron to insert a universal personal identifier card such as a credit card in a suitable card reader. When received by the central gaming machine server 20, the identity information read from the credit card can then be associated with a unique patron identification used to establish and identify a patron account.

In another embodiment, a more formal registration procedure may require (1) the patron to submit to the operator various types of information such as name, address, social security number, credit card number, Bluetooth device identification data, etc., (2) the patron to be assigned a unique patron identification based on the various types of information submitted, and (3) a patron account to be established and associated with the unique patron identification.

In yet another embodiment, in order to establish a patron account the patron may be asked to enter identifying information unique to the patron via a touch screen at the gaming machine 22 or another designated machine. The identifying information may include any information unique to the patron that is easily remembered and does not require the patron to carry an item having the identifying information (e.g., an item such as a credit card, a player tracking card, a Bluetooth™ handheld device, a player tracking card, etc.).

For example, the patron may be required to enter two pieces of information selected from the patron's height, shoe size, or hat size, the last 4 digits of the patrons home phone number, the last 4 digits of the patron's social security number, a numeric address, the patron's first name, last name, middle name or a combination thereof, the name of a pet owned by the patron, the patron's mother's maiden name, city of birth, favorite color, lucky number, a wedding date, etc. When received by the central gaming machine server 20, the two pieces of identifying information are compared to other combinations of previously entered identifying information from other patrons. If the two pieces of identifying information form a unique combination (i.e., no other patron has previously used them as identifying information), the central gaming machine server 20 may ask the patron to enter a third piece of identifying information via the touch screen. Alternatively, the central gaming machine server 20 may remove one of the two pieces identifying information and then ask the patron to enter a third piece of identifying information via the touch screen. The central gaming machine server 20 may then associate these pieces of identifying information with a unique patron identification and establish a patron account for the patron with the patron account being identified by the unique patron identification. As will be appreciated by those skilled in the art, various types and combinations of identifying information may be used to establish the patron account via the touch screen.

Subsequent to first time identification of the patron and establishment of the patron's account, the central gaming machine server 20 can identify the patron when the patron provides to the gaming machine 22 a universal personal identifier either having, or associated with, the patron's unique patron identification. Therefore, when the universal personal identifier is a magnetic card such as a credit card, an optical card, or an IC card such as a SmartCard™, subsequent collection of patron accounting data is initiated when the card reader 24 reads patron identification data from an appropriate field on the card and the central gaming machine server 20 (or the gaming machine 22) correlates it to the unique patron identification. When the universal personal identifier is patron entry of identifying information unique to the patron (e.g., mother's maiden name), subsequent collection of patron accounting data is initiated when the central gaming machine server 20 correlates the entered identifying information to the unique patron identification. Similarly, when the universal personal identifier is a Bluetooth™ device, subsequent collection of patron accounting data is initiated when the Bluetooth™ module 215 of the gaming machine 22 receives patron identification data from the Bluetooth™ device and the central gaming machine server 22 correlates it to the unique patron identification, and when the universal personal identifier is an implanted microchip, subsequent collection of patron accounting data is initiated when the microchip scanner 216 of the gaming machine 22 receives patron identification information and the central gaming machine server 22 correlates it to the unique patron identification.

During operation, in response to detecting a patron's unique patron identification via a universal personal identifier, a controller associated with the gaming machine 22 transmits the unique patron identification to the central gaming machine server 20. The unique patron identification is then verified by the central gaming machine server 20 and correlated to the patron's house account or other suitable patron account. After identity verification is completed, some or all of the patron account information may be transmitted to the gaming machine 22 for display to the identified patron. The patron account information may include credits available, promotional award information, gaming history information, lodging, entertainment and dining information, and any other suitable patron account information.

Subsequent wagering game play information including patron accounting data resulting from game play by the identified patron on the gaming machine 22 is transmitted to the central gaming machine server 20 and is stored in designated fields of the game play database 25. Therefore, in addition to each identified patron's name, address, unique patron identification, etc., the data stored in the game play database 25 may include wagering games played, win/loss information such as amounts wagered, amounts won and lost, patron gaming preferences, tax identification data, promotional awards and/or credits, to name a few. Data stored in the game play database 25 can then be analyzed for a variety of purposes including targeted marketing, rewards, etc. Additional server(s) (not separately illustrated) coupled to the gaming machines 22 and/or the game play database 25 (e.g., a database manager server) may also be utilized to manage and route the gaming play information.

It may also be desirable to store financial account information associated with registered patrons in the game play database 25. If storage of financial account information on a per-patron basis is desired, real-time cashless verification and/or retrieval of stored financial account information can be accommodated using the server-based gaming system 10. In addition, it may be desirable to store data associated with bonusing events (e.g., multiple jackpots, progressive jackpots, bonus jackpots, etc.) in the game play database 25.

As mentioned above, each of the gaming machines 22 may be manufactured by one of any number of gaming machine manufacturers (“manufactures”) to play one of any number of wagering base games and/or bonus games. Due in part to the many gaming machines available to the patron at any gaming venue, it may be desirable for manufacturers to track gaming machine play on a per-patron basis using universal personal identifiers. By associating gaming data to identified patrons of their gaming machines, a manufacturer may offer incentive programs to the identified patrons to encourage patron loyalty to the manufacturer. Thus, if a manufacturer incentive program is offered to patrons of the server-based gaming system 10, the game play database 25 may be adapted to store patron specific game play data related to the manufacturer's gaming machines on a per-patron basis.

Point-of-Sale Network

Referring to the POS network 16, each of the POS terminals 32 is preferably implemented as a computerized cash register adapted to collect value (i.e., money) associated with identified patrons spending activity and may include a key board, a computer with a display, a barcode scanner/reader, a cash register drawer, a receipt or label printer, a patron pole display, the card reader 124, to name a few. In addition, each of the POS terminals 32 may also include a biometric device(s) 12, the Bluetooth™ module 215, the microchip scanner 216, or combinations thereof.

The central POS server 30, including among other things a microprocessor, a clock, and an operating system, is configured to monitor and issue commands to, and/or download POS software including inventory management software, video store retail software, restaurant/bar retail software, etc., to the POS terminals 32. In addition, the central POS server 30 is configured to collect and integrate patron identification data and associated patron accounting data resulting from patron spending activity, and then analyze the patron accounting data using data mining or other suitable techniques. The patron accounting data may include, among other things, audit data (e.g., the amount of value input received at each POS terminal 32) related to patron spending activity at lodging areas, restaurants, shops, and entertainment venues, etc., terminal configuration data, terminal maintenance data, and terminal security data, to name a few. Therefore, when a universal personal identifier such as a Smart card, an eye scan, patron entry of his place of birth and last 4 digits of his social security number, a Bluetooth™ PDA, etc., is detected via a suitable device of the POS terminal 32 (e.g., the card reader 124), the central POS server 30 can associate the individual patron's identity with patron accounting data collected during spending activity and further allow the patron to access their patron account information from one or more venue locations suitably configured.

A POS database 35, communicatively coupled to the central POS server 30 via the bus or data link 33, enables data storage and retrieval of the patron identification and patron accounting data resulting from patron spending activity. Although one POS database 35 is illustrated, it is contemplated that more or less databases may be included in the POS network 16. In addition, although not shown, a POS database controller or server may be included in the POS network 16 for management of the POS database 35. Further, the coupling of the central POS server 30 to the central gaming machine server 20 enables data storage and retrieval by the central POS server 30 of patron accounting data and patron information from wagering game play.

As mentioned above, the central POS server 30 is configured to collect and integrate patron identification data and associated patron accounting data resulting from patron spending activity. After completion of the patron registration procedure, the central POS server 30 can identify the patron when the patron provides to the POS terminal 32 a universal personal identifier either having, or associated with, the unique patron identification. Therefore, when the universal personal identifier is a magnetic card such as a credit card, an optical card, or an IC card such as a SmartCard™, subsequent collection of patron accounting data is initiated when the card reader 24 reads patron identification data from an appropriate field on the card and the central POS server 30 (or the POS terminal 32) correlates it to the unique patron identification. When the universal personal identifier is patron entry of identifying information unique to the patron (e.g., mother's maiden name), subsequent collection of patron accounting data is initiated when the central gaming machine server 20 correlates the entered identifying information to the unique patron identification. Similarly, when the universal personal identifier is a Bluetooth™ device, subsequent collection of patron accounting data is initiated when the Bluetooth™ module 215 of the POS terminal 32 receives patron identification data from the Bluetooth™ device and the central POS server 30 correlates it to the unique patron identification, and when the universal personal identifier is an implanted microchip, subsequent collection of patron accounting data is initiated when the microchip scanner 216 of the POS terminal 32 receives patron identification information and the central POS server 30 correlates it to the unique patron identification.

During operation, in response to detecting a patron's unique patron identification via a universal personal identifier, a controller associated with the POS terminal 32 transmits the unique patron identification to the central POS server 30. The unique patron identification is then verified by the central POS server 30 and correlated to the patron's house account or other suitable patron account. After identity verification is completed, some or all of the patron account information may be transmitted to the POS terminal 32 for display to the identified patron. The patron account information may include lodging, entertainment and dining information, credits available, promotional award information, gaming history information, and any other suitable patron account information.

Subsequent information including patron accounting data resulting from spending activities by the identified patron via the POS terminal 32 is transmitted to the central POS server 30 and is stored in designated fields of the POS database 35. Therefore, in addition to each identified patron's name, address, unique patron identification, etc., the data stored in the POS database 35 may include a amount of money spent by the patron in a single operator's restaurant, a amount of money spent by the patron in multiple operator's restaurants, an amount of money spent by the patron at a gaming venue, and promotional awards, to name a few. Data stored in the POS database 35 can then be analyzed for a variety of purposes including targeted marketing, rewards, etc. Additional server(s) (not separately illustrated) coupled to the POS terminals 32 and/or the POS database 35 (e.g., a database manager server) may also be utilized to manage and route the gaming play information.

Therefore, whether the patron is engaged in game play via the gaming network 12 or another spending activity via the POS network 16, use of one or more of the universal personal identifiers discussed above allows the operator(s) to track the patron's activity and further allows the patron to access their patron information from a single operator or from multiple operators, depending on the configuration of the server-based gaming system 10. The operator (or the gaming machine manufacturer) may then target the identified player with specific marketing strategies, promotional events, free food or drinks, free or reduced lodging, etc. Utilization of one of any number universal personal identifiers frees the patron from the burden of carrying different player tracking cards for different operator's gaming venues. In addition, utilization of one of any number universal personal identifiers frees the patron from the burden of the correct player tracking card for a particular operator's gaming venue. Further, the method and server-based gaming system configured to associate a patron with wagering game play at a gaming machine may be implemented alone or in conjunction with existing player tracking systems.

FIG. 2 is a perspective view of an embodiment of a gaming machine 22 configured to receive universal personal identifiers in accordance with the invention. The gaming machine 22 may be any type of wagering gaming machine configured to receive universal personal identifiers and therefore may have varying structures and methods of operation. For example, the gaming machine 22 may be a mechanical spinning reel gaming machine (with or without an arm mechanism), or it may be a video gaming machine configured to play a video wagering, and so on. For exemplary purposes, various elements of the gaming machine 22 are described below, but it should be understood that numerous other elements may exist and may be utilized in any number of combinations to create a variety of gaming machine types.

Referring to FIG. 2, the gaming machine 22 includes a cabinet 112 having a door 114 to provide access to the interior of the gaming machine 22. Attached to the door 114 are audio speaker(s) 117 and a belly glass area 118 that typically displays game theme artwork. The audio speaker(s) 117 may be used to generate a variety of sounds such as the sound of spinning slot machine reels, a dealer's voice, music, announcements or any other audio related to the wagering game.

Also attached to the door 114 are a number of value input devices that allow a patron to insert value for game play. The value input devices may include a coin slot acceptor 120 or a note acceptor 122 to input value to the gaming machine 22. The note acceptor 122 may accept value in any number of forms, including currency or a currency-sized paper ticket voucher inscribed with information such as a bar code representing value, the name of the casino, the date, etc. As used herein, the term “value” may encompass gaming tokens, coins, paper currency, ticket vouchers; magnetic cards (e.g., a credit card), optical cards, integrated circuit cards (e.g., a smart card), and any other object representative of value.

Card Reader

The gaming machine 22 may also include a patron tracking area 123 having the card reader 124, a keypad 125 and a display 126. As will be appreciated by those of ordinary skill in the art, the patron tracking area 123 may be located in any number of areas of the gaming machine 22. Further, the display 126 may be implemented using a vacuum fluorescent display (VFD), a liquid crystal display (LCD), an LED display, and/or a touch screen to display information to a game patron or casino employee.

The card reader 124 is used to read patron identity data from a universal personal identification card (e.g., a magnetic card, an optical card, a bar coded card, and a memory card including compact flash cards, memory sticks, smart cards, radio frequency (RF) cards, combination smart cards, hybrid cards, etc.) offered by a patron. The card reader 124 may therefore be any one of a (1) magnetic card reader configured to scan and read patron identity data from ABA/ISO/ANSI formatted data on a track 1 magstripe of a magnetic card such as a credit card, (2) an optical card reader configured to read patron identity data from a slot matrix of an optical card, (3) a bar code reader, (4) an IC card reader configured to read patron identity data from a memory device of the IC card. The patron identity data may include, or be associated with, the unique patron identification. The card reader 124 may also be a (5) hybrid card reader or (6) a combination card reader such as a ST-40 A combination smart card and magnetic card reader, available from SecureTech Corporation, Torrance, Calif.

Touch Screen

The gaming machine 22 may also include a touch screen preferably on a main display device 131 of the gaming machine. It is contemplated however, that one or more touch screen(s) may be located elsewhere on the gaming machine. The touch screen is configured to, among other things, enable the patron to enter identifying information in an interactive fashion. Once properly entered by the patron, the identifying information can be associated with a unique patron identification assigned to the patron to allow patron to establish and then access to their patron account. The information may include any identifying information unique to the patron that is easily remembered and does not require the patron to have an item that includes the identifying information in their immediate possession.

Biometric Reader

The gaming machine 22 may also include a biometric reader 127. Although shown on a player control panel 144, as will be appreciated by those of ordinary skill in the art, the biometric reader 127 may be located in any number of areas of the gaming machine 22. The biometric reader 127 is configured to read patron identity data from a universal personal identification biometric such as a fingerprint, a handprint, a hand geometry measurement, a retinal scan, an iris scan, a facial scan, a voice, etc. The patron identity data may include, or be associated with, the unique patron identification. The biometric reader 127 may therefore be a fingerprint reader with either optical or silicon sensors (available from Custom Micro Products Limited in the U. K.), a HandKey® Handreader (available from Locknetics in New York), a facial recognition scanner (available from Imagis Technologies, Inc. In Washington D.C.), a handprint reader, an iris reader, etc. to name a few In addition, because the universal personal identification biometric may be included in a biometric template (e.g., a biometric template such as an iCLASS™ credential available from HID Corporation), an optical card, a bar encoded card, or an IC card (e.g., a SmartCard™ with a digitally scanned fingerprint), the biometric reader 127 may therefore additionally include or be associated with an optical card reader, an IC card reader, a bar code card reader or a specialized biometric card reader for use with biometric templates. Further, in those cases where the universal personal identification biometric is used in conjunction with a manually entered password or PIN number, a touch screen may be included with the biometric reader 127.

Bluetooth™ Module,

The gaming machine 22 may also include a Bluetooth™ module 215 (see, FIG. 3) such as a Bluetooth™ Module, model No. UGPZ1 available from ALPS Electric Company, to enable personal identification of a patron via short range wireless communication. Using a portable Bluetooth™ device such as a Bluetooth™ mobile telephone (e.g., Bluetooth™ Handset Mobile Phone available from Motorola, Inc.) or a portable Bluetooth™ handheld device or PDA (e.g., an iPAQ Pocket PC available from Compaq Computer Corp.) at the gaming machine 22, the patron can identify himself/herself to the server-based gaming system 10. Identification of the patron may be accomplished via a variety of Bluetooth technology characteristics linking the unique patron identification to the portable Bluetooth™ device. For example, the unique patron identification may linked to a 48 bit unique address associated with firmware of a Bluetooth™ PDA device. Similarly, the patron may be identified via an individual phone number associated with Bluetooth™ mobile telephone, or a combination of the 48 bit unique address and phone number. Thus, when the 48 bit unique address or mobile phone number is detected by a controller of the gaming machine 22 or POS terminal 32, the 48 bit unique address or mobile phone number is correlated to the unique patron identification by the server 20 or 30. If further authentication of the patron using the portable Bluetooth™ device is required, additional identification techniques (e.g., biometrics, PIN numbers) such as described above may be used in conjunction with the patron identification detected via the Bluetooth™ module 215.

Microchip Scanner

Additionally, the gaming machines 22 may be configured with a microchip scanner 216 (see, FIG. 3) such as the microchip scanner available from Applied Digital Solutions of Palm Beach, Fla. The microchip scanner is capable of a reading patron's serial number from a microchip (e.g., a VeriChip™ available from Applied Digital Solutions) implanted in the patron's body. The patron's serial number is linked to the patron's identity information. Thus, once implanted in patron's arm for example, the microchip, linked to patron identity data, can be used by the gaming machines 22 to enable identification of the patron.

Referring again to FIG. 2, the gaming machine 22 also includes the main display device 131 configured with a video display for displaying video game images (e.g., simulated reel symbols in the case of a slot game, simulated cards, simulated numbers, etc.) during game play. Such a video display may be implemented as a CRT, an LCD, a plasma display, or other type of video display suitable for use in a gaming machine, and may be configured with or without a touch screen. The main display device 131 may additionally include a player touch screen to enable player selections, player identification, and/or any other suitable information such as player instructions, etc. In addition, the main display device 31 may display animation, 2-D images, 3-D images or digital video playback, to name a few. The gaming machine 22 may also include a top box 134 having additional speaker(s) 136 and a top box display device 138 to enable a number of game enhancements such as bonus games, interactive tournament games, progressive jackpot games, etc.

The gaming machine 22 also includes the player control panel 144 having a number of pushbuttons or touch-sensitive areas (i.e., touch screen) that may be pressed by a patron to select games, make wagers, make gaming decisions, etc. The number of pushbuttons may include one or more “Bet” buttons for wagering, a “Max Bet” button for making the maximum wager allowable for the game, a “Play” button for beginning pay, a “Repeat” button for repeating the previous wagering selection, a “Collect” button for terminating play and cashing out of the game, a “Help” button for viewing a help screen, a “See Pays” button for causing the main display device 131 to generate one or more display screens showing the odds or payout information for the game or games provided by the gaming machine 22, and a “Call Attendant” button for calling an attendant. Further, although the player control panel 144 is shown to be separate from the main display device 131, it should be understood that the player control panel 144 could be generated by the main display device 131 as a touch-sensitive screen.

In the case of a slot machine, the player control panel 144 may also include a number of wager selection buttons that allow a patron to specify a wager amount for each pay line selected (via selecting multiple amounts of the smallest wager accepted). In addition, the gaming machine 22 may include a number of pay line selection buttons that allow the patron to select one of a number of possible of pay lines prior to spinning the reels. For example, five selection buttons may be provided to allow a patron to select one, three, five, seven or nine pay lines prior to each reel spin.

When a patron inserts value in the gaming machine 22, credits corresponding to the amount deposited are shown on a credit meter of the gaming machine 22. After depositing the appropriate amount of value and making suitable selections, the patron can begin game play by pulling the mechanical arm or by pushing an appropriate button such as the Bet button, the Max Bet button, or the Play button on the player control panel 144. Game play outcome may be determined either centrally or locally (1) using a random number generator (RNG) resulting in a pseudo random set of outcomes, or (2) by selecting a game outcome from a fixed set of outcomes (pooled), or (3) other suitable technique.

FIG. 3 is a block diagram of a number of components that may be incorporated in each of the gaming machine(s) 22 and POS terminals 32 of FIG. 1. Referring to FIG. 3, each of the gaming machine(s) 22 and POS terminals 32 includes a controller 200 that may comprise a program memory 202, a microcontroller-based platform or microprocessor (MP) 204, a random-access memory (RAM) 206 and an input/output (I/O) circuit 208, all of which may be interconnected via a communications link, or an address/data bus 210. The microprocessor 204 is capable of controlling the display of images, symbols and other indicia such as characters, people, places, things, and faces of cards to be displayed. The RAM 206 is capable of storing event data (e.g., coins-in, coins-out, games played, amount spent) or other data used or generated during game play or patron spending activity. The program memory 202 is capable of storing program code which controls each of the gaming machine(s) 22 and POS terminals 32. Although the program memory is preferably implemented as a non-volatile read only memory (ROM), it could also be a flash or battery backed RAM in order for the program memory 202 to be updated by a coupled server or floor controller.

It should be appreciated that although only one microprocessor 204 is shown, the controller 200 may include multiple microprocessors 204. For example, the controller 200 may include one microprocessor for executing low level functions and another processor for executing higher level functions such as some communications, security, maintenance, etc. Similarly, the memory of the controller 200 may include multiple RAMs 206 and multiple program memories 202. Although the I/O circuit 208 is shown as a single block, it should be appreciated that the I/O circuit 208 may include a number of different types of I/O circuits. The RAM(s) 206 and program memory(s) 202 may be implemented as semiconductor memories, magnetically readable memories, and/or optically readable memories, etc. Further, the term “controller” is used herein to refer collectively to the program memory 202, the microprocessor 204, the RAM 206 and the I/O circuit 208.

FIG. 3 illustrates that multiple peripheral devices, depicted as peripheral devices 211, 212, and 214, may be operatively coupled to the I/O circuit 208. In the case of the gaming machine 22, the peripheral devices may include the player control panel 144 with buttons, a coin slot acceptor, a note acceptor, a bill validator, a keypad, a sound circuit driving speakers, a card reader display, a video display, a touch screen, the card reader 124, the biometric reader 127, the microchip scanner 216, etc. In the case of POS terminal 32, the peripheral devices may include a keyboard, a patron display pole, a cash register drawer, the touch screen, the card reader 124, the biometric reader 127, the microchip scanner 216, etc., similarly coupled to the I/O circuit 208.

It should be appreciated that although the controller 200 is a preferable implementation of the present invention, the present invention also includes implementation via one or more application specific integrated circuits (ASICs), field programmable gate arrays (FPGAs), adaptable computing integrated circuits, one or more hardwired devices, or one or more mechanical devices.

One manner in which the gaming machine 22 may utilize universal personal identifiers to access patron accounts within the server-based gaming system 10 is described in connection with FIG. 4. FIG. 4 is an exemplary high level ladder diagram illustrating the use of a Bluetooth™ technology-based personal identifier for accessing patron information/account(s) within the server-based gaming system of FIG. 1. Although a Bluetooth device in conjunction with the gaming machine 22 is utilized to illustrate the use of universal personal identifiers, it should be appreciated that other universal personal identifiers described above in conjunction with the gaming machine 22 or the POS terminal 32 may be utilized in a similar fashion to establish and then access a patron account.

Referring to FIG. 4, using a portable Bluetooth™ handheld device 402 (“Bluetooth device 402”) at a gaming machine 22 or a POS terminal 32, a registered (discussed in connection with FIG. 1) patron can be identified by the central gaming machine server 20 for purposes of accessing their patron account and associated databases. As previously mentioned, the gaming machine 22 (and/or the POS terminal 32) may include a Bluetooth™ module 215 (“Bluetooth module 215”) having a transceiver and antenna for short-range, low power communication. When made discoverable and connectable via the gaming machine controller 200 (step 402), the Bluetooth module 215 is capable of (1) responding to inquires from other Bluetooth devices and (2) subsequently establishing a wireless Bluetooth communication link for purposes of patron identification. For example, when the Bluetooth device 402 in the discoverable mode (the initiator) moves to a location within a preset range (e.g., three feet) of the gaming machine 22 having the Bluetooth module 215 (the acceptor), an inquiry is transmitted to from the Bluetooth device 402 to the Bluetooth module 215 (step 404). The Bluetooth module 215 responds with its address (step 408). Similarly, a name discovery is transmitted from the Bluetooth device 402 to the Bluetooth module 215 (step 410) and the Bluetooth module 215 responds with its module name (step 412). In addition, the gaming machine controller 200, or an individual controller of the Bluetooth module 215, enables the Bluetooth module 215 to be paired with the Bluetooth device 402 (step 414).

Next, through a series of requests from the Bluetooth device 402 and a series of acceptances from the Bluetooth module 215, a physical link is established (step 416), a channel, or a logical link, is established (step 418), and a connection between the applications (i.e., the higher layers) is established (step 420). Authentication and encryption negotiation ensure that the Bluetooth module 215 and the Bluetooth module 215 are in secure modes during link and channel establishment.

In the case of the gaming machine 22, upon establishment of the connection between applications (step 420), unique identification information associated with the Bluetooth device 402 is transmitted from the Bluetooth device 402 to the Bluetooth module 215 (step 422), to the gaming machine controller 200 (step 424) and then to the central gaming machine server 20 (step 426). The unique identification information provides to the central gaming machine server 20 the registered patron's identity. The unique identification information may include the unique 48 bit address of the Bluetooth device 402 (from which a device access code is generated for the session), the class of device, the device name, a combination thereof, among other things. Thus one or a combination of identifiers associated with the Bluetooth device 402 may be used as a unique personal identifier. If further authentication of the patron is desired, authentication methods discussed above such as biometric inputs, PIN numbers, etc. may be entered in the gaming machine 22 before access to patron information and related databases is allowed.

Upon acquiring and verifying the patron's identity via unique identification information such as the unique 48 bit address of the Bluetooth device 402, the central gaming machine server 22 notifies the gaming machine controller 200 that patron access to patron information/account(s) is permitted (step 428) and enables such access (step 430). The patron information may include any number of game play related items associated with the patron such as personal gaming statistics, spending information, performance information, financial information, accounting information, promotional incentives, rewards, etc.

When game play by the patron is complete, the patron information/account(s) and associated databases (e.g., player tracking, bonus, accounting, etc.) are updated with information and/or awards resulting from the game play. When the update is completed, the gaming machine controller 200 and, if necessary, the Bluetooth module 215 are notified (step 434) of the completed status and the Bluetooth channel is released (step 436). Alternatively, when the Bluetooth module 215 no longer detects the presence of the Bluetooth device 402, the patron information/account(s) and associated databases are updated with information and/or awards resulting from the game play and the gaming machine controller 200 is notified accordingly. Although scanning algorithms performed by the Bluetooth module 215 and the Bluetooth device 402 can be used to detect the absence of the Bluetooth device 402 (indicating cessation of game play) other suitable means for detecting cessation of game play (e.g., patron logout, timer expire, etc.) may also be implemented by the server-based gaming system 10.

Although discussed in terms of the gaming network 12, the exemplary high level ladder diagram of FIG. 4 can be similarly applied to the POS network 16. For example, upon establishment of the connection between applications (step 420), unique identification information associated with the Bluetooth device 402 is transmitted from the Bluetooth device 402 to the Bluetooth module 215 (step 422), to the POS controller 200 (step 424) and then to the central POS terminal server 30. The identification information is then used by the central POS terminal server 30 as the unique personal identifier for the registered patron possessing the Bluetooth device 402. If authentication of the patron possessing the Bluetooth device 402 is desired, authentication methods discussed above such as biometric inputs, PIN numbers, etc. may be entered in the POS terminal 32 before access to patron information and related databases is allowed.

Therefore in addition to patron accounting data generated from game play, accounting data from dining, shopping, entertainment, lodging, and parking may be collected via the point of sale terminals 32 and tracked, mined as described in connection with the gaming network 12. Thus, as a result of utilizing a universal personal identifier in conjunction with the point of sale terminal(s) 32, the spending habits of an identified patron can be monitored and rewarded without the need for an operator specific player tracking card.

As may be apparent from the discussion above, the present invention enabling patron identification at a gaming venue using one of any number of universal personal identifiers described above enables patron information and associated account(s) to be accessed by a suitable gaming operator or the identified and registered patron without the restrictions typically associated with traditional operator-specific player tracking cards. Thus, a patron who forgets to bring his/her traditional player tracking cards to the operator's gaming venue will not be penalized in terms of incentive awards, etc., will not have to reapply for another operator-specific player tracking card and will not have to limit game play at that operator's venue on that occasion or go to another operator's gaming venue. Utilization of one of any number universal personal identifiers with the gaming machine 22 and the POS terminal 32 frees the patron from the burden of carrying different player tracking cards for different operator's gaming venues and frees the patron from the burden of the having the correct player tracking card for a particular operator's gaming venue.

Further, although some gaming venue operators may feel that they have an advantage over their competitors if they have a large patron base carrying their operator-specific player tracking cards, they may likely discover that deploying gaming networks 12 or POS networks 16 having universal personal identifier devices as described above, will allow them to enhance customer loyalty by providing a more convenient method for patron activity to be tracked and rewarded accordingly.

From the foregoing, it will be observed that numerous variations and modifications may be affected without departing from the scope of the novel concept of the invention. It is to be understood that no limitations with respect to the specific methods and apparatus illustrated herein is intended or should be inferred. It is, of course, intended to cover by the appended claims all such modifications as fall within the scope of the claims.

1. A method for associating a patron with wagering game play at a gaming machine in a server-based gaming network, the method comprising:
associating a unique patron identification with the patron;
establishing a patron account for the patron, the patron account being identified by the unique patron identification;
associating the gaming machine with a universal personal identifier device for receiving a universal personal identifier having a patron identification, the universal personal identifier device capable of detecting and transmitting the patron identification;
receiving the patron identification;
comparing the patron identification to the unique patron identification; and
enabling collection of patron accounting data resulting from wagering game play if the patron identification matches the unique patron identification.

2. The method of claim 1, wherein the universal personal identifier device comprises a card reader.

3. The method of claim 2, wherein the universal personal identifier comprises a credit card.

4. The method of claim 2, wherein the universal personal identifier is selected from the group consisting of a magnetic card, an optical card, a bar coded card, and a memory card.

5. The method of claim 4, wherein the memory card is selected from the group consisting of a compact flash card, a memory stick, a smart card, a radio frequency card, a combination smart card, and a hybrid card.

6. The method of claim 1, wherein the universal personal identifier device comprises a biometric device, and wherein the universal personal identifier comprises a biometric input by the patron.

7. The method of claim 1, wherein the universal personal identifier device comprises a touch screen, and wherein the universal personal identifier comprises identifying information entered by the patron, the identifying information unique to the patron and easily remembered by the patron.

8. The method of claim 1, wherein the universal personal identifier device comprises a Bluetooth™ module device, and wherein the universal personal identifier comprises a Bluetooth™ mobile phone.

9. The method of claim 1, wherein the universal personal identifier device comprises a Bluetooth™ module device, and wherein the universal personal identifier comprises a Bluetooth™ handheld device.

10. The method of claim 1, wherein the universal personal identifier device comprises a microchip scanner, and wherein the universal personal identifier comprises a microchip embedded in the patron.

11. The method of claim 1, further comprising:
detecting a wager for wagering game play at the gaming machine;
collecting the patron accounting data resulting from wagering game play; and
providing the patron accounting data to the patron account.

12. The method of claim 11, further comprising enabling the patron to access the patron account if the patron identification matches the unique patron identification.

13. The method of claim 11, further comprising:
applying a promotional credit to the patron account based on the patron accounting data;
enabling the patron to access the patron account if the patron identification matches the unique patron identification;
enabling the patron to transfer the promotional credit to the gaming machine; and
permitting the patron to wager the promotional credit for wagering game play on the gaming machine.

14. The method of claim 1, wherein the wagering game is selected from the group consisting of mechanical slots, video slots, video poker, video blackjack, video keno and video bingo.

15. A method for associating a patron with spending activity at a point of sale terminal in a server-based gaming network, the method comprising:
associating a unique patron identification with the patron;
establishing a patron account for the patron, the patron account being identified by the unique patron identification;
associating the point of sale terminal with a universal personal identifier device for receiving a universal personal identifier having a patron identification, the universal personal identifier device capable of detecting and transmitting the patron identification;
receiving the patron identification;
comparing the patron identification to the unique patron identification; and
enabling collection of patron accounting data resulting from spending activity if the patron identification matches the unique patron identification.

16. The method of claim 15, wherein the universal personal identifier device comprises a card reader.

17. The method of claim 16, wherein the universal personal identifier comprises a credit card.

18. The method of claim 16, wherein the universal personal identifier is selected from the group consisting of a magnetic card, an optical card, a bar coded card, and a memory card.

19. The method of claim 18, wherein the memory card is selected from the group consisting of a compact flash card, a memory stick, a smart card, a radio frequency card, a combination smart card, and a hybrid card.

20. The method of claim 15, wherein the universal personal identifier device comprises a touch screen, and wherein the universal personal identifier comprises identifying information entered by the patron, the identifying information unique to the patron and easily remembered by the patron.

21. The method of claim 15, wherein the universal personal identifier device comprises a biometric device, and wherein the universal personal identifier comprises a biometric input by the patron.

22. The method of claim 15, wherein the universal personal identifier device comprises a Bluetooth™ module device, and wherein the universal personal identifier comprises a Bluetooth™ mobile phone.

23. The method of claim 15, wherein the universal personal identifier device comprises a Bluetooth™ module device, and wherein the universal personal identifier comprises a Bluetooth T handheld device.

24. The method of claim 15, wherein the universal personal identifier device comprises a microchip scanner, and wherein the universal personal identifier comprises a microchip embedded in the patron.

25. The method of claim 15, further comprising:
detecting spending activity of the patron via the point of sale terminal;
collecting the patron accounting data resulting from the spending activity; and
providing the patron accounting data to the patron account.

26. The method of claim 25, further comprising enabling the patron to access the patron account if the patron identification matches the unique patron identification.

27. The method of claim 25, further comprising:
applying a promotional credit to the patron account based on the patron accounting data;
enabling the patron to access the patron account if the patron identification matches the unique patron identification;
enabling the patron to transfer the promotional credit to the point of sale terminal; and
permitting the patron to apply the promotional credit towards spending activity.

28. The method of claim 15, wherein the spending activity is selected from the group consisting of lodging spending, restaurant spending, entertainment spending, and merchandise spending.

29. A method for associating a patron with wagering game play at a gaming machine in a server-based gaming network, the method comprising:
associating a unique patron identification with the patron;
establishing a patron account for the patron, the patron account being identified by the unique patron identification;
associating the gaming machine with a Bluetooth™ module for receiving a unique identity bit stream having a patron identification from a Bluetooth™ portable device, the Bluetooth™ module capable of detecting and transmitting the patron identification;
detecting establishment of a Bluetooth™ wireless connection between the Bluetooth™ module and the Bluetooth™ portable device;
receiving the patron identification via the Bluetooth™ wireless connection;
comparing the patron identification to the unique patron identification; and
enabling collection of patron accounting data resulting from wagering game play if the patron identification matches the unique patron identification.

30. The method of claim 29, wherein the Bluetooth™ portable device comprises a Bluetooth™ mobile phone.

31. The method of claim 29, wherein the Bluetooth™ portable device comprises a Bluetooth™ handheld device.

32. The method of claim 29, wherein detecting establishment of a Bluetooth T wireless connection comprises:
detecting establishment of a Bluetooth™ link between the Bluetooth™ module and the Bluetooth™ portable device;
detecting establishment of a Bluetooth™ channel between the Bluetooth™ module and the Bluetooth™ portable device; and
detecting establishment of a Bluetooth™ high layer connection between the Bluetooth™ module and the Bluetooth™ portable device.

33. The method of claim 29, further comprising:
detecting a wager for wagering game play at the gaming machine;
collecting the patron accounting data resulting from wagering game play; and
providing the patron accounting data to the patron account.

34. The method of claim 33, further comprising enabling the patron to access the patron account if the patron identification matches the unique patron identification.

35. The method of claim 33, further comprising:
applying a promotional credit to the patron account based on the patron accounting data;
enabling the patron to access the patron account if the patron identification matches the unique patron identification;
enabling the patron to transfer the promotional credit to the gaming machine; and
permitting the patron to wager the promotional credit for wagering game play on the gaming machine.

36. The method of claim 29, further comprising disabling collection of the patron accounting data resulting from wagering game play when the Bluetooth™ wireless connection between the Bluetooth™ module and the Bluetooth™ portable device is not established.

37. The method of claim 29, wherein the wagering game is selected from the group consisting of mechanical slots, video slots, video poker, video blackjack, video keno and video bingo.

38. A server-based gaming network that allows a patron with a universal personal identifier to be associated with wagering game play at a gaming machine, the server-based gaming network comprising:
a plurality of gaming machines, at least one of the gaming machines comprising:
a value input device;
a video display capable of displaying video images associated with the wagering game play;
a universal personal identifier device configured to receive a universal personal identifier having a patron identification, and configured to detect the patron identification from the universal personal identifier; and
a gaming machine controller operatively coupled to the value input device, the video display and the universal personal identifier device, the gaming machine controller comprising a processor and a memory coupled to the processor of the gaming machine controller, the gaming machine controller being programmed to:
receive the patron identification from the universal personal identifier device,
allow the patron to make a wager for the wagering game play,
cause a video image representing an outcome of the wagering game play to be displayed on the video display, and
determine a value payout associated with the outcome; and
a server operatively coupled to the at least one of the gaming machines, the server comprising:
a server controller, the server controller comprising a processor and a memory coupled to the processor of the server controller, the server controller being programmed to:
associate a unique patron identification with the patron,
establish a patron account for the patron, the patron account being identified by the unique patron identification,
receive the patron identification from the gaming machine controller,
compare the patron identification to the unique patron identification, and
enable collection of patron accounting data resulting from the wagering game play if the patron identification matches the unique patron identification.

39. The server-based gaming network of claim 38, wherein the universal personal identifier device comprises a card reader.

40. The server-based gaming network of claim 39, wherein the universal personal identifier comprises a credit card.

41. The server-based gaming network of claim 39, wherein the universal personal identifier is selected from the group consisting of a magnetic card, an optical card, a bar coded card, and a memory card.

42. The server-based gaming network of claim 41, wherein the memory card is selected from the group consisting of a compact flash card, a memory stick, a smart card, a radio frequency card, a combination smart card, and a hybrid card.

43. The server-based gaming network of claim 38, wherein the universal personal identifier device comprises a touch screen, and wherein the universal personal identifier comprises identifying information entered by the patron, the identifying information unique to the patron and easily remembered by the patron.

44. The server-based gaming network of claim 38, wherein the universal personal identifier device comprises a biometric device, and wherein the universal personal identifier comprises a biometric input by the patron.

45. The server-based gaming network of claim 38, wherein the universal personal identifier device comprises a Bluetooth™ module device, and wherein the universal personal identifier comprises a Bluetooth™ mobile phone.

46. The server-based gaming network of claim 38, wherein the universal personal identifier device comprises a Bluetooth™ module device, and wherein the universal personal identifier comprises a Bluetooth™ handheld device.

47. The server-based gaming network of claim 38, wherein the universal personal identifier device comprises a microchip scanner, and wherein the universal personal identifier comprises a microchip embedded in the patron.

48. The server-based gaming network of claim 38, wherein the server controller is further programmed to:
detect a wager for the wagering game play at the at least one of the gaming machines;
collect the patron accounting data resulting from the wagering game play; and
provide the patron accounting data to the patron account.

49. The server-based gaming network of claim 48, wherein the server controller is further programmed to enable the patron to access the patron account if the patron identification matches the unique patron identification.

50. The server-based gaming network of claim 48, wherein the server controller is further programmed to:
apply a promotional credit to the patron account based on the patron accounting data;
enable the patron to access the patron account if the patron identification matches the unique patron identification;
enable the patron to transfer the promotional credit to the at least one of the gaming machines; and
permit the patron to wager the promotional credit for the wagering game play on the at least one of the gaming machines.
